(19) United States
(12) Patent Application Publication
(10) Pub. No.: US 2026/0268422 A1
(43) Pub. Date: Sep. 10, 2026

(54) SYSTEM

(71) Applicant: SOFTBANK GROUP CORP., Tokyo (JP)

(72) Inventor: Tomoaki KITANO, Tokyo (JP)

(73) Assignee: SOFTBANK GROUP CORP., Tokyo (JP)

(21) Appl. No.: 19/555,981

(22) Filed: Mar. 4, 2026

Related U.S. Application Data
(60) Provisional application No. 63/767,130, filed on Mar. 5, 2025.

(51) Int. Cl. G06Q 50/12; G06Q 10/083; G06Q 20/10; G06Q 30/0201; G06Q 30/0283; G10L 15/08; G10L 25/63

(52) U.S. Cl. CPC G06Q 50/12; G06Q 10/083; G06Q 20/102; G06Q 30/0206; G06Q 30/0283; G10L 15/08; G10L 25/63; G10L 2015/088

(57) ABSTRACT

A system that proposes dishes based on the user's mood, selects a delivery method, and handles payment consistently is disclosed. The analysis unit analyzes the mood input by the user via a terminal using natural language processing technology, extracting emotions and keywords. The proposal unit searches a database for related dishes based on the extracted keywords and proposes them to the user. The user selects one dish from the proposals and chooses a delivery method from “Make it myself,” “Delivery,” or “Restaurant.” The selection unit makes the necessary arrangements based on this information, and the payment unit completes the payment by linking with a secure payment platform. This enables users to quickly and efficiently select and arrange meals suited to their mood. Furthermore, by incorporating options that consider food loss and options for providing meals to others, it can also address social issues.

### CROSS-REFERENCE TO RELATED APPLICATION

This application claims priority under 35 U.S.C. § 119 to U.S. Provisional Patent Application No. 63/767,130, filed on Mar. 5, 2025, the entire contents of which are incorporated herein by reference.

### BACKGROUND

### Technical Field

The present disclosure relates to a system.

### Related Art

Japanese Patent Application Publication Laid-Open (JP-A) No. 2022-180282 discloses a persona chatbot control method performed by at least one processor, comprising: a step of receiving a user utterance; a step of adding to the user utterance a prompt containing a description of the chatbot's persona and related instructions; a step of encoding the prompt; and a step of inputting the encoded prompt into a language model to generate a chatbot utterance in response to the user utterance.

A system and method for reducing the hassle and time wasted when users select and arrange meals suited to their current mood is provided. In modern society, choosing meals amidst busy daily lives often causes stress, and selecting meals according to one's mood is particularly difficult. Conventional methods require users to either devise recipes themselves, procure ingredients, and cook, or choose appropriate options from numerous choices when dining out or using delivery services. This process demands time and effort, and selecting options that match one's mood is especially challenging.

Furthermore, issues like food waste and food loss are serious concerns, adding further complexity to meal choices that consider these factors. Additionally, providing or sharing meals with others requires even more effort.

A system for solving these challenges by analyzing the user's mood and proposing the optimal meal based on that analysis is provided. For the proposed meal, the user can easily select the serving method and complete the necessary arrangements within the system. This allows users to quickly and efficiently select and enjoy meals that match their mood. Furthermore, by incorporating options that consider food loss and choices for providing meals to others, it also addresses societal challenges. In this way, the user's dining experience is enhanced while contributing to solving societal issues.

As a means to solve the problem, a system that integrates a series of processes: analyzing the user's mood, proposing dishes based on that analysis, selecting the delivery method, and processing payment is provided. This system consists of four main components: an analysis unit, a proposal unit, a selection unit, and a payment unit.

First, the analysis unit analyzes text input by the user using natural language processing technology to extract emotions and keywords. This analysis enables accurate understanding of the user's mood and preferences.

Next, the proposal unit searches the database for relevant dishes based on keywords obtained from the analysis unit and proposes multiple dishes to the user. These proposals are presented alongside dish descriptions and images to offer options matching the user's mood.

Subsequently, the selection unit enables the user to choose one dish from the proposed options and further select a delivery method from “Make it myself,” “Delivery,” or “Restaurant.” This allows the user to choose the optimal delivery method according to their situation and preferences.

Finally, the payment section processes the payment corresponding to the selected delivery method through a secure payment platform. This payment process includes purchasing ingredients, paying for delivery, or making restaurant reservations, depending on the delivery method the user selected.

By combining these components, users can quickly and efficiently select and arrange meals that suit their mood. Furthermore, because the entire system is integrated, users enjoy a consistent experience, significantly reducing the stress and time wasted associated with meal selection.

### BRIEF DESCRIPTION OF THE DRAWING

FIG. 1 is a conceptual diagram showing an example configuration of the data processing system according to the first embodiment.

FIG. 2 is a conceptual diagram showing an example of key functions of the data processing device and smart device according to the first embodiment.

FIG. 3 is a conceptual diagram showing an example configuration of the data processing system according to the second embodiment.

FIG. 4 is a conceptual diagram showing an example of the main functions of the data processing device and smart glasses according to the second embodiment.

FIG. 5 is a conceptual diagram showing an example configuration of a data processing system according to a third embodiment.

FIG. 6 is a conceptual diagram showing an example of the main functions of the data processing device and headset-type terminal according to the third embodiment.

FIG. 7 is a conceptual diagram showing an example configuration of a data processing system according to the fourth embodiment.

FIG. 8 is a conceptual diagram showing an example of the main functions of the data processing device and robot according to the fourth embodiment.

FIG. 9 shows an emotion map onto which multiple emotions are mapped.

FIG. 10 shows an emotion map onto which multiple emotions are mapped.

### DETAILED DESCRIPTION

The following describes an example embodiment of a system according to the present disclosure with reference to the accompanying drawings.

First, the terminology used in the following description is explained.

In the following embodiments, a processor (hereinafter simply referred to as a “processor”) may be a single arithmetic unit or a combination of multiple arithmetic units. Furthermore, the processor may be a single type of arithmetic unit or a combination of multiple types of arithmetic units. Examples of processing units include a CPU (Central Processing Unit), a GPU (Graphics Processing Unit), a GPGPU (General-Purpose Computing on Graphics Processing Units), an APU (Accelerated Processing Unit), and the like.

In the following embodiments, signed RAM (Random Access Memory) is a memory where information is temporarily stored and is used as working memory by the processor.

In the following embodiments, the encoded storage is one or more non-volatile storage devices that store various programs and various parameters, etc. Examples of non-volatile storage devices include flash memory (SSD (Solid State Drive)), magnetic disks (e.g., hard disk), or magnetic tape.

In the following embodiments, the coded communication interface is an interface including a communication processor and an antenna, etc. The communication interface governs communication between multiple computers. Examples of communication standards applicable to the communication interface include wireless communication standards such as 5G (5th Generation Mobile Communication System), Wi-Fi (registered trademark), or Bluetooth (registered trademark).

In the following embodiments, “A and/or B” is synonymous with “at least one of A and B.” That is, “A and/or B” means that it may be only A, only B, or a combination of A and B. Furthermore, in this specification, when three or more matters are expressed by connecting them with “and/or,” the same concept applies as for “A and/or B”.

### First Embodiment

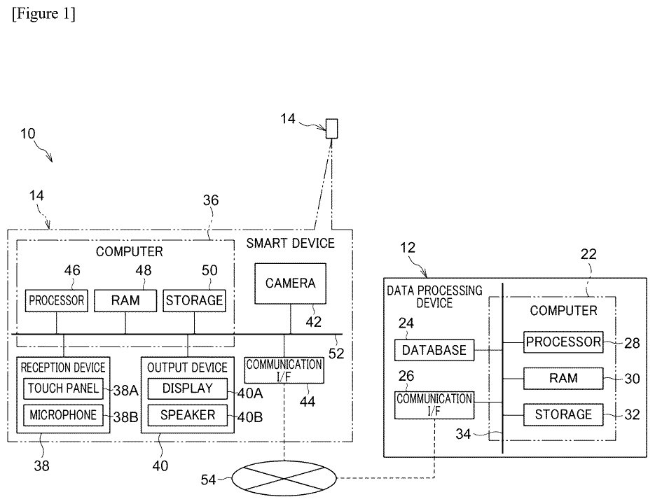

FIG. 1 shows an example configuration of the data processing system 10 according to the first embodiment.

As shown in FIG. 1, the data processing system 10 includes a data processing device 12 and a smart device 14. An example of the data processing device 12 is a server.

The data processing device 12 includes a computer 22, a database 24, and a communication I/F 26. The computer 22 is an example of a “computer” according to the technology of the present disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 include a WAN (Wide Area Network) and/or a LAN (Local Area Network).

The smart device 14 includes a computer 36, a reception device 38, an output device 40, a camera 42, and a communication I/F 44. The computer 36 includes a processor 46, RAM 48, and storage 50. The processor 46, RAM 48, and storage 50 are connected to a bus 52. The reception device 38, output device 40, and camera 42 are also connected to the bus 52. The reception device 38, output device 40, and camera 42 are also connected to the bus 52.

The reception device 38 includes a touch panel 38A and a microphone 38B, among other components, and receives user input. The touch panel 38A receives user input via contact with an input device (e.g., a pen or finger) by detecting such contact. The microphone 38B receives voice-based user input by detecting the user's voice. The control unit 46A transmits data indicating user input received via the touch panel 38A and microphone 38B to the data processing unit 12. The data processing device 12 acquires the data indicating the user input via the specific processing unit 290.

The output device 40 includes a display 40A and a speaker 40B, among others. It presents data to the user 20 by outputting it in a form perceptible to the user 20 (e.g., voice and/or text). The display 40A displays visual information such as text and images according to instructions from the processor 46. The speaker 40B outputs voice according to instructions from the processor 46. The camera 42 is a compact digital camera equipped with an optical system including a lens, aperture, and shutter, and an imaging element such as a CMOS (Complementary Metal-Oxide-Semiconductor) image sensor or a CCD (Charge Coupled Device) image sensor.

The communication I/F 44 is connected to the network 54. The communication I/Fs 44 and 26 manage the exchange of various information between processor 46 and processor 28 via network 54.

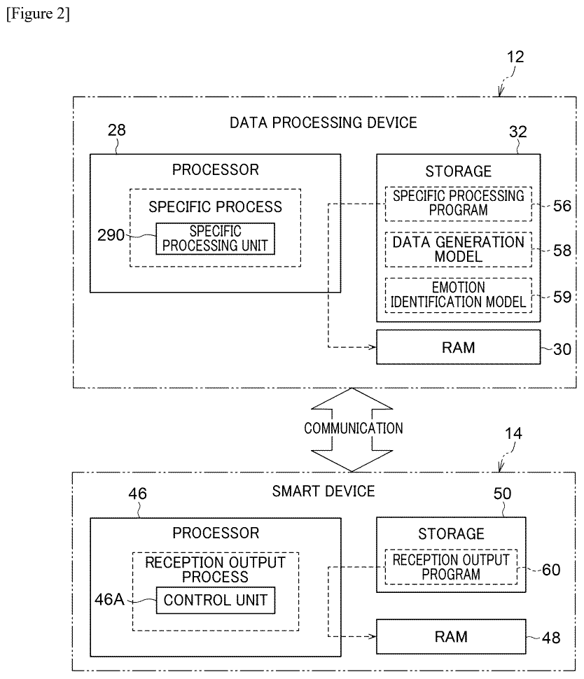

FIG. 2 shows an example of the main functions of the data processing device 12 and the smart device 14.

As shown in FIG. 2, specific processing is performed by processor 28 in data processing device 12. Specific processing program 56 is stored in storage 32. Specific processing program 56 is an example of a “program” related to the technology of this disclosure. The processor 28 reads the specific processing program 56 from the storage 32 and executes the read specific processing program 56 on the RAM 30. The specific processing is realized by the processor 28 operating as a specific processing unit 290 according to the specific processing program 56 executed on the RAM 30.

Storage 32 stores a data generation model 58 and an emotion identification model 59. The data generation model 58 and emotion identification model 59 are used by specific processing unit 290. Specific processing unit 290 can estimate a user's emotion using emotion identification model 59 and perform specific processing using the user's emotion. The emotion estimation function (emotion identification function) using the emotion identification model 59 performs various estimations and predictions concerning the user's emotion, including estimation and prediction of the user's emotion, but is not limited to such examples. Furthermore, estimation and prediction of emotion also includes, for example, analysis (parsing) of emotion.

The smart device 14 performs reception output processing via the processor 46. The reception output program 60 is stored in the storage 50. The reception output program 60 is used in conjunction with the specific processing program 56 by the data processing system 10. The processor 46 reads the reception output program 60 from the storage 50 and executes the read reception output program 60 on the RAM 48. The specific processing is performed by the processor 46 operating as a control unit 46A according to the specific processing program 60 executed on the RAM 48. Note that the smart device 14 may also have data generation models and emotion identification models similar to the data generation model 58 and emotion identification model 59, and may perform processing similar to that of the specific processing unit 290 using these models. The reception output processing is realized by the processor 46 operating as the control unit 46A according to the reception output program 60 executed on the RAM 48.

Other devices besides the data processing device 12 may also have the data generation model 58. For example, a server device (e.g., a generation server) may have the data generation model 58. In this case, the data processing device 12 communicates with the server device having the data generation model 58 to obtain processing results (such as prediction results) obtained using the data generation model 58. Furthermore, the data processing device 12 may itself be a server device, or it may be a terminal device owned by a user (e.g., a mobile phone, robot, home appliance, etc.). Next, an example of processing by the data processing system 10 according to the first embodiment is described.

### EXAMPLE 1

The flow of specific processing in Example 1 is described below. The components of the system described below are implemented by the data processing device 12 and the smart device 14. The data processing device 12 is referred to as the “server,” and the smart device 14 is referred to as the “terminal.”

### Implementation Examples for Carrying Out the Invention

The details of implementing the system using a server and a terminal for carrying out the present invention are described more specifically below.

This system implements a series of processes: proposing dishes based on the user's mood, selecting the delivery method, and completing payment. The functions of the analysis unit, proposal unit, selection unit, and payment unit are distributed and implemented by the server and terminal.

First, the user inputs their mood using the terminal. The terminal is a device such as a smartphone, tablet, or personal computer, accepting text input via a user interface. The user can input specific moods or situations, such as “I'm tired today, so I want something energizing to eat” or “I want a meal I can enjoy with friends.” The input text is sent from the terminal to the server.

On the server side, the analysis unit receives this input text and performs analysis using natural language processing technology. The analysis unit executes algorithms to extract emotions and keywords from the text, identifying specific moods or preferences such as “tired,” “energizing,” or “enjoying with friends.” This analysis result is then passed to the proposal unit.

The proposal unit, built on the server, searches the database for relevant dishes based on keywords obtained from the analysis unit. The database stores information on various dishes. For example, for “feeling energized,” it includes dishes like steak or curry that replenish energy; for “enjoying with friends,” it includes dishes like pizza or tapas that are easy to share. The proposal unit organizes this dish information and generates a list to propose to the user. This list includes the dish name, image, brief description, cooking time, calorie information, nutritional value, and so on.

The generated list of dish recommendations is sent from the server to the terminal and displayed to the user on the terminal. The user selects one dish from the recommendations displayed on the terminal screen. For example, if the user selects “steak,” the terminal sends the selection information to the selection section on the server.

The Selection Module operates on the server and manages the process of choosing the delivery method for the dishes selected by the user. Users can select a delivery method from “Make It Yourself,” “Delivery,” or “Restaurant” on their device, and the Selection Module receives this information. For example, if “Make It Yourself” is selected, the Selection Module generates a steak recipe and a list of required ingredients, and creates links to provide information about nearby supermarkets or online grocery stores. This includes real-time inventory and price information for the nearest stores based on the user's location, and presents the optimal purchasing options to the user.

The payment unit runs on the server and manages the payment process corresponding to the selected delivery method. This includes payments for ingredient purchases, delivery orders, and restaurant reservation deposits. The payment unit interfaces with a secure payment platform, enabling users to complete payments seamlessly through their device. Specifically, it supports multiple payment methods such as credit cards, electronic money, and bank transfers, enhancing user convenience.

In this way, the system achieves a seamless process from meal suggestions tailored to the user's mood, through delivery method selection, to payment, through the coordinated operation of the server and terminal. This enables users to quickly and efficiently select and arrange meals that match their current mood. Furthermore, the integrated system provides users with a consistent experience, significantly reducing the stress and time wasted associated with meal selection. Additionally, incorporating options that consider food waste and the ability to provide meals to others enables the system to address social issues.

### System Configuration

The system according to this embodiment comprises an analysis unit, a proposal unit, a selection unit, a payment unit, a user interface unit, and a database unit. The analysis unit receives text describing the user's mood entered via a terminal and analyzes it using natural language processing technology. Specifically, when a user enters text such as “I want to relax today” or “I want something spicy,” the analysis unit extracts keywords like “relax” and “spicy” from these sentences to identify the user's emotions and preferences. This analysis employs sentiment analysis algorithms and keyword extraction technology to achieve high-precision analysis of user input.

The proposal unit searches the database unit for relevant dishes based on keywords obtained from the analysis unit. The database unit stores information on various dishes; for example, “relax” might include herbal tea or pasta, while “spicy” might include curry or Mexican cuisine. The proposal unit organizes this dish information and generates a list to propose to the user. This list includes the dish name, image, brief description, cooking time, calorie information, nutritional value, etc., and is visually organized to facilitate user selection.

The Selection Unit allows the user to choose one dish from the proposed list and further select a serving method from “Cook at Home,” “Delivery,” or “Restaurant.” For example, if a user selects “Steak” and chooses “Cook at Home,” the Selection Unit generates a steak recipe and a list of required ingredients, along with links to nearby supermarkets or online grocery stores. This includes functionality to retrieve real-time inventory and price information from the nearest stores based on the user's location, presenting the optimal purchasing options.

The payment section manages the payment process corresponding to the selected delivery method. This includes payments for purchasing ingredients, ordering delivery, or paying restaurant reservation deposits. The payment section interfaces with secure payment platforms, enabling users to complete payments seamlessly through their devices. Specifically, it supports multiple payment methods such as credit cards, electronic money, and bank transfers, enhancing user convenience.

The User Interface Unit provides an interface for users to interact with the system. Users can input their mood, select dishes, choose delivery methods, and confirm payments via terminals such as smartphones, tablets, or PCs. The interface is designed to be intuitive and easy to use, ensuring smooth operation for users.

The database component manages a database for storing information about dishes. This database includes dish names, images, descriptions, cooking times, calorie information, nutritional values, ingredient lists, and information about restaurants where the dish is available. The database is regularly updated, adding new dishes and seasonal menus to provide users with the latest information at all times.

Specific examples of prompt sentences to be fed into the generative AI required for implementing the present invention include: “Design an algorithm to analyze the mood entered by the user and suggest relevant dishes,” “Design a data structure to generate a list of dish suggestions and display it on the user interface,” and “Design a flow to determine the serving method based on the user's selection and manage the payment process.” These prompt sentences form the foundation for the system's components to operate in coordination and are crucial elements for providing a consistent experience to the user.

### Implementation Steps

### Step 1: Mood Input

The user inputs their current mood using a terminal. In this step, the user expresses their mood in free text format via the user interface using devices such as smartphones, tablets, or PCs. For example, they can input specific moods or preferences like “I want to relax today” or “I want something spicy.” The input data is immediately sent to the server.

### Step 2: Mood Analysis

The server-side analysis unit receives the mood-related text sent by the user and analyzes it using natural language processing technology. In this step, sentiment analysis algorithms and keyword extraction techniques are employed to extract keywords like “relax” or “spicy” from the text. When using generative AI, a possible prompt could be: “Design an algorithm to analyze the user's mood and extract relevant keywords.”

### Step 3: Dish Proposal

Based on keywords obtained from the analysis unit, the proposal unit searches the database for related dishes. The database stores information on various dishes; for example, “herbal tea” or “pasta” for “relax,” and “curry” or “Mexican cuisine” for “spicy.” The proposal unit organizes this dish information and generates a list to present to the user. This list includes the dish name, image, brief description, cooking time, calorie information, nutritional value, etc. When using generative AI, a possible prompt could be: “Design a data structure to generate a list of dish proposals and display it on the user interface.”

### Step 4: Selecting the Delivery Method

The user selects one dish from the suggestions on their device and further chooses a delivery method from “Cook at Home,” “Delivery,” or “Restaurant.” The Selection Unit receives this information. For example, if “Cook at Home” is selected, it generates the steak recipe and a list of required ingredients and generate links to nearby supermarkets or online grocery stores. Based on the user's location, it retrieves real-time inventory and price information from the nearest stores and presents the optimal purchasing options to the user.

### Step 5: Execute Payment

The payment section manages the payment process according to the selected delivery method. This includes payments for ingredient purchases, delivery orders, restaurant reservation deposits, etc. The payment unit interfaces with secure payment platforms to enable users to complete payments seamlessly through their devices. Specifically, it supports multiple payment methods such as credit cards, e-money, and bank transfers to enhance user convenience. When using generative AI, a possible prompt could be: “Design a flow to determine the delivery method based on user selection and manage the payment process.”

### Specific Use Cases

For example, consider a situation where a user has finished a long day of work and wants to relax. This user accesses the system via their smartphone and inputs “I want a relaxing meal today” through the user interface. This input is sent from the device to the server and received by the analysis unit. The analysis unit uses natural language processing technology to extract the keyword “relax” and identify the user's mood.

Based on the keyword obtained from the analysis unit, the proposal unit searches the database for related dishes. The database includes dishes known for their relaxing effects, such as herbal tea, pasta, and soup. The proposal unit organizes these dishes and generates a list to present to the user. This list includes the dish name, image, brief description, cooking time, calorie information, and nutritional value, visually organized to facilitate user selection.

The user selects “pasta” from the dishes suggested on the device screen and chooses “make it myself” as the preparation method. The selection unit receives this information and generates the pasta recipe and a list of required ingredients. Furthermore, based on the user's location information, it generates links to provide information on nearby supermarkets and online grocery stores. This includes the capability to obtain real-time inventory status and price information from the nearest stores and present the user with the optimal purchasing options.

The payment unit manages payments for purchasing ingredients. Users can complete payments via the terminal using credit cards or electronic money. The payment unit interfaces with a secure payment platform to enable users to complete payments seamlessly.

Specific examples of prompt sentences to be fed into the generative AI required to implement the present invention include: “Design an algorithm to analyze the mood entered by the user and suggest related dishes,” “Design a data structure to generate a list of dish suggestions and display it on the user interface,” and “Design a flow to determine the delivery method based on the user's selection and manage the payment process.” These prompt sentences form the foundation for the system's components to operate in coordination and are crucial elements for providing a consistent experience to the user.

### (Application Example 1

The flow of specific processing in Application Example 1 is described below. Each part of the system described below is implemented by the data processing device 12 and the smart device 14. The data processing device 12 is referred to as the “server,” and the smart device 14 is referred to as the “terminal.”

### Implementation Examples for the Present Invention

The embodiment for implementing the present invention is described in further detail below. The present invention is a system that proposes optimal meals based on a user's mood and health status and provides them promptly through a food delivery service. This system comprises an analysis unit, a proposal unit, a selection unit, a payment unit, a user interface unit, and a database unit.

First, the user interface unit provides an interface for the user to input their mood or health condition. The user accesses the application using a smartphone or tablet and can input specific requests such as “I'm tired today,” “I want to limit calories,” or “I want to get more vitamins.” The interface is intuitive and designed to allow easy input by providing options. Furthermore, it includes voice input functionality, enabling users to input their mood or health status vocally. For example, if a user inputs “I want energy today” via voice, the system converts this to text and sends it to the analysis unit.

Next, the analysis unit receives the information sent by the user and performs analysis using natural language processing technology. The analysis unit extracts keywords such as “fatigue recovery,” “low calories,” and “vitamin intake” from the input information to identify the user's needs. For example, if the user inputs “I'm tired today,” the analysis unit extracts keywords related to “fatigue recovery” and provides feedback to the proposal unit. By employing machine learning algorithms for this analysis, it achieves higher accuracy by considering the user's past selection history and preferences.

The proposal unit searches the database unit for relevant meals based on keywords obtained from the analysis unit. The database unit stores nutritional value, calorie information, cooking methods, and information on available restaurants. For example, for “fatigue recovery,” it includes vitamin C-rich salads or protein smoothies suitable for energy replenishment; for “low calorie,” it includes grilled chicken or tofu dishes. The proposal unit organizes this meal information and generates a list for user recommendations. This list includes dish names, images, brief descriptions, nutritional values, and calorie information, visually organized for easy user selection. Furthermore, the proposal unit can make personalized recommendations by considering the user's past selection history.

The Selection Section enables users to choose one meal from the suggestions and specify the delivery time and location. Upon receiving this information, the Selection Section sends the order to partner restaurants or delivery services. For example, if a user selects “Vitamin C Salad” and specifies delivery to their home at 7 PM, the Selection Section uses this information to select the optimal restaurant and confirm the order. The delivery service then schedules the meal for delivery at the user's specified time. The selection unit obtains real-time inventory status and available delivery times from nearby stores based on the user's location information, presenting the optimal delivery options to the user.

The payment section manages payment for the selected meal. Users can complete payment via the application using credit cards, electronic money, or bank transfers. The payment section interfaces with secure payment platforms to enable users to complete payments seamlessly. After payment is completed, a confirmation notification is sent to the user displaying the order details. Furthermore, the Payment Module supports multiple currencies, enabling it to accommodate international users.

Thus, the present invention enables the rapid and efficient selection and arrangement of optimal meals tailored to the user's mood and health condition. Because the entire system is integrated, users enjoy a consistent experience, significantly reducing the stress and time wasted associated with meal selection. Furthermore, by incorporating options that consider food loss and the ability to provide meals to others, the system can also address social issues. For example, it can provide a platform for users to share leftover ingredients with other users, supporting efforts to reduce food loss.

### System Configuration

The system according to this embodiment comprises an analysis unit, a proposal unit, a selection unit, a payment unit, a user interface unit, and a database unit. The analysis unit receives information about the user's mood or health status entered via a terminal and analyzes it using natural language processing technology. Specifically, if a user enters information such as “I'm tired today” or “I want to cut calories,” the analysis unit extracts keywords like “recover from fatigue” or “low calorie” from this information. By employing machine learning algorithms for this analysis, it achieves higher accuracy by considering the user's past selection history and preferences.

The Proposal Unit searches the Database Unit for relevant meals based on keywords obtained from the Analysis Unit. The Database Unit stores nutritional value, calorie information, cooking methods, and details of restaurants offering the meals. For example, “Fatigue Recovery” might include vitamin C-rich salads or protein smoothies suitable for energy replenishment, while “Low Calorie” might include grilled chicken or tofu dishes. The proposal unit organizes this meal information and generates a list for user recommendations. This list includes dish names, images, brief descriptions, nutritional values, and calorie information, visually organized for easy user selection. Furthermore, the proposal unit can make personalized recommendations by considering the user's past selection history.

The Selection Section enables users to choose one meal from the suggestions and specify the delivery time and location. Upon receiving this information, the Selection Section sends the order to partner restaurants or delivery services. For example, if a user selects “Vitamin C Salad” and specifies delivery to their home at 7 PM, the Selection Section uses this information to choose the optimal restaurant and confirm the order. The delivery service then schedules the meal for delivery at the user's specified time. The selection unit obtains real-time inventory status and available delivery times from nearby stores based on the user's location information, presenting the optimal delivery options to the user.

The payment unit manages payment for the selected meal. Users can complete payment via the application using credit cards, electronic money, or bank transfers. The payment unit interfaces with secure payment platforms to enable users to complete payments seamlessly. After payment is completed, a confirmation notification is sent to the user displaying the order details. Furthermore, the payment unit supports multiple currencies, enabling it to accommodate international users.

The User Interface Unit provides an interface for users to input their mood and health status. Users can access the application via smartphone or tablet and input specific requests such as “I'm tired today,” “I want to limit calories,” or “I want to increase my vitamin intake.” The interface is intuitive and designed to facilitate easy input by providing options. Furthermore, it incorporates voice input functionality, allowing users to input their mood or health status verbally.

The database section manages a database storing nutritional values, calorie information, cooking methods, and information on available restaurants. This database is regularly updated, adding new dishes and seasonal menus to provide users with the latest information at all times. The database forms the foundation for making meal suggestions tailored to the user's health status and preferences.

Specific examples of prompt sentences to be fed into the generative AI required to implement the present invention include: “Design a meal recommendation algorithm considering the user's health status,” “Design an order flow integrated with delivery services,” and “Build a meal database based on nutritional value.” These prompts form the foundation for the system's components to operate in coordination and are crucial elements for providing users with a consistent experience.

### Implementation Steps

### Step 1: User Information Input

Users input information about their mood and health status via an application using smartphones or tablets. The interface is intuitive, allowing users to select specific requests from options such as “I'm tired today,” “I want to cut calories,” or “I want to get more vitamins,” or freely input text. It also features voice input functionality, enabling users to input information verbally.

### Step 2: Information Analysis

The analysis unit on the server receives information sent by the user and analyzes it using natural language processing technology. The analysis unit extracts keywords such as “fatigue recovery,” “low calories,” and “vitamin intake” from the input information to identify the user's needs. When using generative AI, a possible prompt could be: “Design an algorithm to analyze the user's input information and extract relevant keywords.”

### Step 3: Meal Proposal

Based on keywords obtained from the analysis unit, the proposal unit searches the database for relevant meals. The database stores nutritional value, calorie information, cooking methods, and details of restaurants offering the meals. The proposal unit organizes this information and generates a list to present to the user. This list includes the dish name, image, brief description, nutritional value, and calorie information. When using generative AI, a prompt such as “Design a data structure to generate a meal proposal list and display it on the user interface” could be considered.

### Step 4: Selecting the Delivery Method

The user selects one meal from the suggestions displayed on the terminal and specifies the delivery time and location. The Selection Unit receives this information and sends the order to partner restaurants or delivery services. Based on the user's location, it obtains real-time inventory status and available delivery times from the nearest stores and presents the optimal delivery option.

### Step 5: Execute Payment

The payment section manages the payment process according to the selected delivery method. Users can complete payment via the application using credit cards, electronic money, or bank transfers. The payment section interfaces with secure payment platforms to enable users to complete payments seamlessly. When using generative AI, a possible prompt could be: “Design a flow to determine the delivery method based on user selection and manage the payment process.”

### Specific Use Cases

For example, consider a situation where a user has just finished a long meeting and wants to replenish their energy. This user accesses the system via their smartphone and inputs “I want energy today” through the application interface. This input can also be made using voice input functionality, enhancing user convenience. The input information is immediately sent to the server and received by the analysis unit.

The analysis unit uses natural language processing technology to extract the keyword “energy replenishment” and identify the user's needs. The analysis unit employs machine learning algorithms to consider the user's past selection history and preferences, achieving higher-precision analysis. This analysis result is fed back to the proposal unit.

The proposal unit searches the database for relevant meals based on keywords obtained from the analysis unit. The database includes meals suitable for energy replenishment, such as protein bars, energy drinks, and pasta dishes rich in carbohydrates. The proposal unit organizes this meal information and generates a list to present to the user. This list includes the dish name, image, brief description, nutritional value, and calorie information, visually organized for easy user selection.

The user selects “protein bar” from the suggested meals displayed on the terminal screen and specifies delivery to the office at 6:00 PM. The selection unit receives this information and sends the order to partner restaurants or delivery services. The selection unit obtains real-time inventory status and available delivery times from the nearest stores based on the user's location information and presents the optimal delivery option.

The payment section manages payment for the meal selected by the user. The user can complete payment via the application using a credit card or electronic money. The payment section interfaces with a secure payment platform to enable the user to complete payment seamlessly. After payment is completed, a confirmation notification is sent to the user displaying the order details.

Specific examples of prompt sentences to be fed into the generative AI required for implementing the present invention include: “Design an algorithm to analyze user input and extract relevant keywords,” “Design a data structure to generate a list of meal suggestions and display it on the user interface,” and “Design a flow to determine the delivery method based on user selection and manage the payment process.” These prompts form the foundation for the system's components to operate in coordination and are critical elements for providing a consistent user experience.

The specific processing unit 290 transmits the results of the specific processing to the smart device 14. On the smart device 14, the control unit 46A instructs the output device 40 to output the results of the specific processing. Microphone 38B acquires audio indicating user input regarding the specific processing result. Control unit 46A transmits the audio data indicating user input acquired by microphone 38B to data processing unit 12. Data processing unit 12 acquires the audio data from specific processing unit 290.

Data Generation Model 58 is what is known as generative AI (Artificial Intelligence). An example of a data generation model 58 is ChatGPT (registered trademark) (Internet search <URL: https://openai.com/blog/chatgpt>). Data generation model 58 is obtained by performing deep learning on a neural network. Data generation model 58 receives input of a prompt containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats, such as audio data, text data, and image data. The data generation model 58 includes, for example, text generation AI, image generation AI, and multimodal generation AI. Here, inference refers to, for example, analysis, classification, prediction, and/or summarization. The specific processing unit 290 performs the aforementioned specific processing while using the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others. The AI may perform various processing operations, but is not limited to such examples. Furthermore, the AI may be an AI agent. Also, when the processing of the aforementioned components is performed by AI, that processing may be performed in part or in whole by AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the smart device 14.

### Second Embodiment

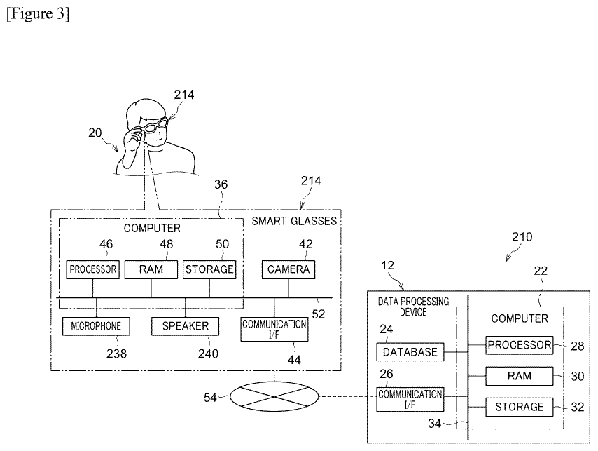

FIG. 3 shows an example configuration of the data processing system 210 according to the second embodiment.

As shown in FIG. 3, the data processing system 210 includes a data processing device 12 and smart glasses 214. An example of the data processing device 12 is a server.

The data processing device 12 includes a computer 22, a database 24, and a communication I/F 26. The computer 22 is an example of a “computer” according to the technology of the present disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 is WAN (Wide Area Network) and/or LAN (Local Area Network) are examples.

Smart glasses 214 include a computer 36, a microphone 238, a speaker 240, a camera 42, and a communication I/F 44. The computer 36 includes a processor 46, RAM 48, and storage 50. Processor 46, RAM 48, and storage 50 are connected to bus 52. Microphone 238, speaker 240, and camera 42 are also connected to bus 52.

Microphone 238 receives voice input from user 20 to accept instructions or other commands. Microphone 238 captures the voice input from user 20, converts the captured voice into audio data, and outputs it to processor 46. Speaker 240 outputs audio in accordance with instructions from processor 46.

The camera 42 is a compact digital camera equipped with an optical system, such as a lens, aperture, and shutter, and an imaging element, such as a CMOS (Complementary Metal-Oxide-Semiconductor) image sensor or a CCD (Charge Coupled Device) image sensor. It captures images of the user's surroundings (e.g., within a field of view equivalent to that of a typical healthy individual).

The communication I/F 44 is connected to the network 54. The communication I/Fs 44 and 26 manage the exchange of various information between processor 46 and processor 28 via network 54. The exchange of various information between processor 46 and processor 28 using communication I/F 44 and 26 is performed in a secure state.

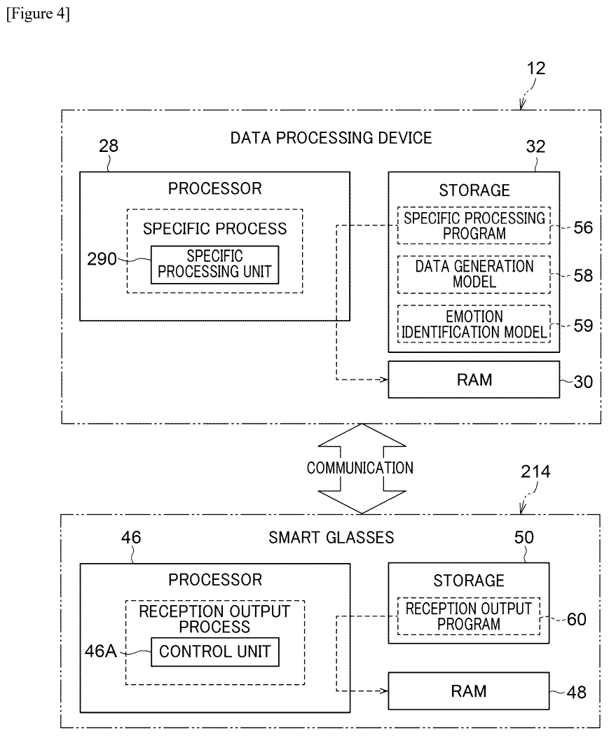

FIG. 4 shows an example of key functions of the data processing device 12 and the smart glasses 214. As shown in FIG. 4, specific processing is performed by the processor 28 in the data processing device 12. The specific processing program 56 is stored in the storage 32.

The specific processing program 56 is an example of a “program” related to the technology of this disclosure. Processor 28 reads the specific processing program 56 from storage 32 and executes the read specific processing program 56 on RAM 30. The specific processing is realized by the processor 28 operating as a specific processing unit 290 according to the specific processing program 56 executed on the RAM 30.

Storage 32 stores a data generation model 58 and an emotion identification model 59. The data generation model 58 and emotion identification model 59 are used by specific processing unit 290. Specific processing unit 290 can estimate a user's emotion using emotion identification model 59 and perform specific processing using the user's emotion. The emotion estimation function (emotion identification function) using the emotion identification model 59 performs various estimations and predictions concerning the user's emotion, including estimation and prediction of the user's emotion, but is not limited to such examples. Furthermore, estimation and prediction of emotion also includes, for example, analysis (parsing) of emotion.

In the smart glasses 214, the processor 46 performs the reception output processing. The reception output program 60 is stored in the storage 50. The processor 46 reads the reception output program 60 from the storage 50 and executes the read reception output program 60 on the RAM 48. The reception output processing is realized by the processor 46 operating as the control unit 46A according to the reception output program 60 executed on the RAM 48. The reception output processing is performed by the processor 46 acting as a control unit 46A according to the reception output program 60 executed on RAM 48. Note that the smart glasses 214 may also have a data generation model 58 and an emotion identification model 59, and can perform processing similar to that of the identification processing unit 290 using these models.

Next, the identification processing performed by the identification processing unit 290 of the data processing device 12 is described. The components of the system described below are implemented by the data processing device 12 and the smart glasses 214. In the following description, the data processing device 12 is referred to as the “server,” and the smart glasses 214 are referred to as the “terminal.”

### EXAMPLE 1

The flow of the specific processing is the same as that described in Example 1 of the first embodiment, so the explanation is omitted.

### Application Example 1

The flow of the specific processing in Example 1 described in the first embodiment is the same as above, so the explanation is omitted.

The specific processing unit 290 transmits the result of the specific processing to the smart glasses 214. In the smart glasses 214, the control unit 46A causes the speaker 240 to output the result of the specific processing. The microphone 238 acquires audio indicating user input regarding the result of the specific processing. The control unit 46A transmits the audio data indicating the user input acquired by the microphone 238 to the data processing device 12. At the data processing device 12, the specific processing unit 290 acquires the audio data.

Data Generation Model 58 is a so-called generative AI (Artificial Intelligence). An example of a data generation model 58 is ChatGPT (registered trademark) (Internet search <URL:https://openai.com/blog/chatgpt>). Data generation model 58 is obtained by performing deep learning on a neural network. Data generation model 58 receives input prompts containing instructions, as well as inference data such as audio data representing sound, text data representing text, and image data (e.g., still image data or video data) representing images. Data generation model 58 infers based on the instructions indicated by the prompt using the input inference data and outputs the inference result in one or more data formats, such as audio data, text data, and image data. The data generation model 58 includes, for example, text generation AI, image generation AI, and multimodal generation AI. Here, inference refers to, for example, analysis, classification, prediction, and/or summarization. The specific processing unit 290 performs the aforementioned specific processing while utilizing the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others. The AI may perform various processing operations, but is not limited to such examples. Furthermore, the AI may be an AI agent. Also, when the processing of the aforementioned components is performed by AI, that processing may be performed in part or in whole by AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the smart glasses 214.

### Third Embodiment

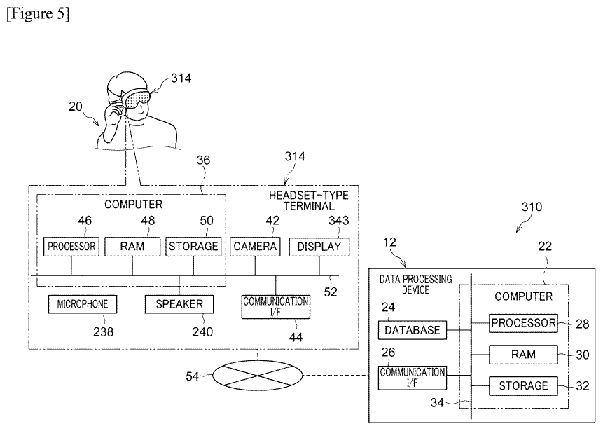

FIG. 5 shows an example configuration of the data processing system 310 according to the third embodiment.

As shown in FIG. 5, the data processing system 310 includes a data processing device 12 and a headset-type terminal 314. An example of the data processing device 12 is a server.

The data processing device 12 includes a computer 22, a database 24, and a communication I/F 26. The computer 22 is an example of a “computer” according to the technology of the present disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 is WAN (Wide Area Network) and/or LAN (Local Area Network) are examples.

The headset-type terminal 314 comprises a computer 36, a microphone 238, a speaker 240, a camera 42, a communication interface 44, and a display 343. The computer 36 includes a processor 46, RAM 48, and storage 50. The processor 46, RAM 48, and storage 50 are connected to a bus 52. The microphone 238, speaker 240, camera 42, and display 343 are also connected to the bus 52.

Microphone 238 receives voice input from user 20 to accept instructions or other commands. Microphone 238 captures the voice input from user 20, converts the captured voice into audio data, and outputs it to processor 46. Speaker 240 outputs audio in accordance with instructions from processor 46.

The camera 42 is a compact digital camera equipped with an optical system, such as a lens, aperture, and shutter, and an imaging element, such as a CMOS (Complementary Metal-Oxide-Semiconductor) image sensor or a CCD (Charge Coupled Device) image sensor. It captures images of the user's surroundings (e.g., an imaging range defined by a field of view equivalent to that of a typical healthy person).

The communication I/F 44 is connected to the network 54. The communication I/Fs 44 and 26 manage the exchange of various information between processor 46 and processor 28 via network 54. The exchange of various information between processor 46 and processor 28 using communication I/F 44 and 26 is performed in a secure state.

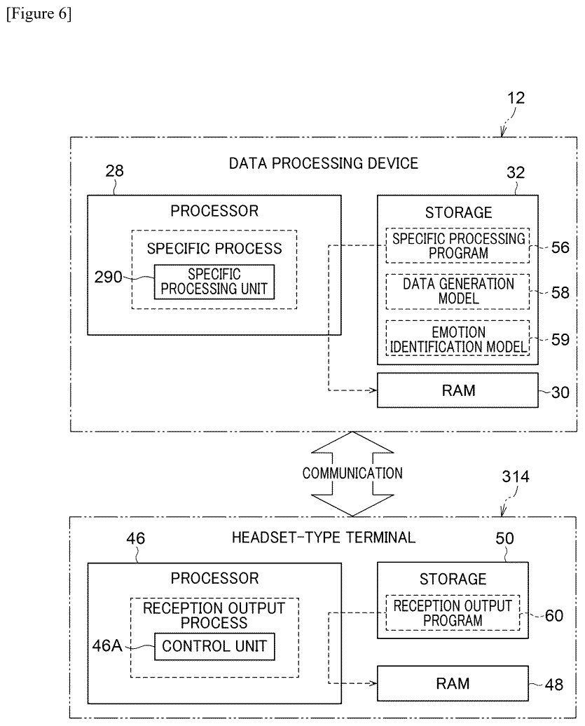

FIG. 6 shows an example of the main functions of the data processing device 12 and the headset-type terminal 314. As shown in FIG. 6, specific processing is performed by the processor 28 in the data processing device 12. The specific processing program 56 is stored in the storage 32.

The specific processing program 56 is an example of a “program” related to the technology of this disclosure. The processor 28 reads the specific processing program 56 from the storage 32 and executes the read specific processing program 56 on the RAM 30. The specific processing is realized by the processor 28 operating as a specific processing unit 290 according to the specific processing program 56 executed on the RAM 30.

Storage 32 stores a data generation model 58 and an emotion identification model 59. The data generation model 58 and the emotion identification model 59 are used by the specific processing unit 290.

In the headset-type terminal 314, the processor 46 performs reception output processing. The reception output program 60 is stored in the storage 50. The processor 46 reads the reception output program 60 from the storage 50 and executes the read reception output program 60 on the RAM 48. The reception output processing is realized by the processor 46 operating as a control unit 46A according to the reception output program 60 executed on the RAM 48. The reception output processing is realized by the processor 46 operating as a control unit 46A according to the reception output program 60 executed on RAM 48.

Next, the specific processing performed by the specific processing unit 290 of the data processing device 12 is described. The various parts of the system described below are implemented by the data processing device 12 and the headset-type terminal 314. In the following description, the data processing device 12 is referred to as the “server,” and the headset-type terminal 314 is referred to as the “terminal.”

### EXAMPLE 1

The flow of the specific processing is the same as that described in Example 1 of the first embodiment, so the description is omitted.

### Application Example 1

The flow of the specific processing in Example 1 described in the above first embodiment is the same, so the explanation is omitted.

The specific processing unit 290 transmits the result of the specific processing to the headset-type terminal 314. At the headset-type terminal 314, the control unit 46A causes the speaker 240 and the display 343 to output the result of the specific processing. The microphone 238 acquires audio indicating user input regarding the result of the specific processing. The control unit 46A transmits the audio data indicating the user input acquired by the microphone 238 to the data processing device 12. At the data processing device 12, the specific processing unit 290 acquires the audio data.

Data Generation Model 58 is a so-called generative AI (Artificial Intelligence). An example of a data generation model 58 is ChatGPT (registered trademark) (Internet search <URL:https://openai.com/blog/chatgpt>). Data generation model 58 is obtained by performing deep learning on a neural network. Data generation model 58 receives input of a prompt containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats, such as audio data, text data, and image data. The data generation model 58 includes, for example, text generation AI, image generation AI, and multimodal generation AI. Here, inference refers to, for example, analysis, classification, prediction, and/or summarization. The specific processing unit 290 performs the aforementioned specific processing while utilizing the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58. The data generation model 58 includes AI other than generative AI. AI other than generative AI includes, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others. The AI may perform various processing operations, but is not limited to such examples. Furthermore, the AI may be an AI agent. Also, when the processing of the aforementioned components is performed by AI, that processing may be performed in part or in whole by AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12. However, the technology disclosed herein is not limited to this, and specific processing may also be performed by the headset-type terminal 314.

### Fourth Embodiment

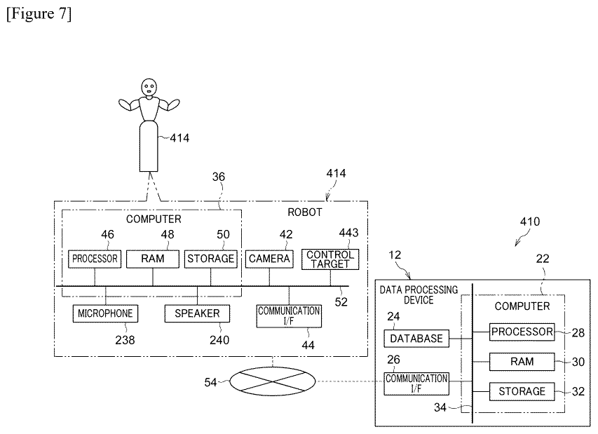

FIG. 7 shows an example configuration of the data processing system 410 according to the fourth embodiment.

As shown in FIG. 7, the data processing system 410 includes a data processing device 12 and a robot 414. An example of the data processing device 12 is a server.

The data processing device 12 includes a computer 22, a database 24, and a communication I/F 26. The computer 22 is an example of a “computer” according to the technology of the present disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 is WAN (Wide Area Network) and/or LAN (Local Area Network) are examples.

Robot 414 includes a computer 36, a microphone 238, a speaker 240, a camera 42, a communication I/F 44, and a control target 443. Computer 36 includes a processor 46, RAM 48, and storage 50. Processor 46, RAM 48, and storage 50 are connected to bus 52. Furthermore, microphone 238, speaker 240, camera 42, and controlled object 443 are also connected to bus 52.

Microphone 238 receives voice output from user 20, thereby accepting instructions and the like from user 20. Microphone 238 captures the voice output from user 20 and converts the captured audio into audio data, which it outputs to the processor 46. The speaker 240 outputs audio in accordance with instructions from the processor 46.

Camera 42 is a compact digital camera equipped with an optical system, such as a lens, aperture, and shutter, and an imaging element, such as a CMOS (Complementary Metal-Oxide-Semiconductor) image sensor or a CCD (Charge Coupled Device) image sensor. It captures images of the user's surroundings (e.g., an imaging range defined by a field of view equivalent to that of a typical healthy person).

The communication I/F 44 is connected to the network 54. The communication I/Fs 44 and 26 manage the exchange of various information between processor 46 and processor 28 via network 54. The exchange of various information between processor 46 and processor 28 using communication I/F 44 and 26 is performed in a secure state.

The control target 443 includes a display device, LEDs for the eye section, and motors for driving the arms, hands, legs, etc. The posture and gestures of robot 414 are controlled by controlling the motors for the arms, hands, legs, etc. Part of the robot 414's emotions can be expressed by controlling these motors. Furthermore, the robot 414's facial expressions can also be expressed by controlling the light emission state of the LEDs in its eyes.

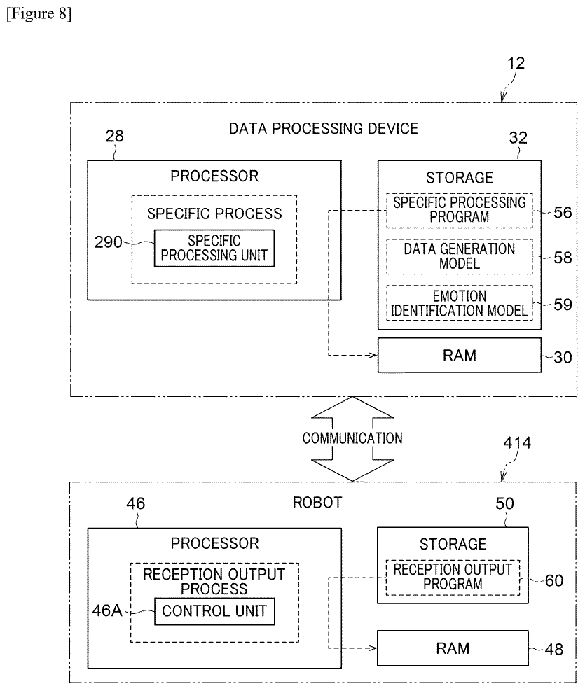

FIG. 8 shows an example of the main functions of the data processing device 12 and the robot 414. As shown in FIG. 8, specific processing is performed by the processor 28 in the data processing device 12. The specific processing program 56 is stored in the storage 32.

The specific processing program 56 is an example of a “program” pertaining to the technology of this disclosure. The processor 28 reads the specific processing program 56 from the storage 32 and executes the read specific processing program 56 on the RAM 30. The specific processing is realized by the processor 28 operating as a specific processing unit 290 according to the specific processing program 56 executed on the RAM 30.

Storage 32 stores a data generation model 58 and an emotion identification model 59. The data generation model 58 and the emotion identification model 59 are used by the specific processing unit 290.

In robot 414, reception output processing is performed by processor 46. Storage 50 stores a reception output program 60. Processor 46 reads the reception output program 60 from storage 50 and executes the read reception output program 60 on RAM 48. Reception output processing is realized by the processor 46 operating as a control unit 46A according to the reception output program 60 executed on RAM 48.

Next, the specific processing performed by the specific processing unit 290 of the data processing device 12 is described. The various parts of the system described below are implemented by the data processing device 12 and the robot 414. In the following description, the data processing device 12 is referred to as the “server,” and the robot 414 is referred to as the “terminal.”

### EXAMPLE 1

The flow of the specific processing is the same as that described in Example 1 of the first embodiment, so the description is omitted.

### Application Example 1

The flow of the specific processing in Example 1 described in the first embodiment is the same as above, so the explanation is omitted.

The specific processing unit 290 transmits the result of the specific processing to the robot 414. In the robot 414, the control unit 46A causes the speaker 240 and the control target 443 to output the result of the specific processing. The microphone 238 acquires audio indicating user input regarding the result of the specific processing. The control unit 46A transmits the audio data indicating the user input acquired by the microphone 238 to the data processing device 12. At the data processing device 12, the specific processing unit 290 acquires the audio data.

Data Generation Model 58 is what is known as generative AI (Artificial Intelligence). An example of a data generation model 58 is ChatGPT (registered trademark) (Internet search <URL:https://openai.com/blog/chatgpt>). Data generation model 58 is obtained by performing deep learning on a neural network. Data generation model 58 receives input of a prompt containing instructions, as well as input of inference data such as audio data representing sound, text data representing text, and image data (e.g., still image data or video data) representing images. The data generation model 58 infers based on the input inference data according to the instructions indicated by the prompt and outputs the inference result in one or more data formats, such as audio data, text data, and image data. The data generation model 58 includes, for example, text generation AI, image generation AI, and multimodal generation AI. Here, inference refers to, for example, analysis, classification, prediction, and/or summarization. The specific processing unit 290 performs the aforementioned specific processing while utilizing the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58. The data generation model 58 includes AI other than generative AI. AI other than generative AI includes, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others. The AI may perform various processing operations, but is not limited to such examples. Furthermore, the AI may be an AI agent. Also, when the processing of the aforementioned parts is performed by AI, that processing may be performed in part or in whole by AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit may acquire step count data using the camera 42 or communication I/F 44 of the smart device 14, and this data is processed by the specific processing unit 290 of the data processing device 12. For example, the analysis unit may be realized by the specific processing unit 290 of the data processing device 12, and it analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the robot 414.

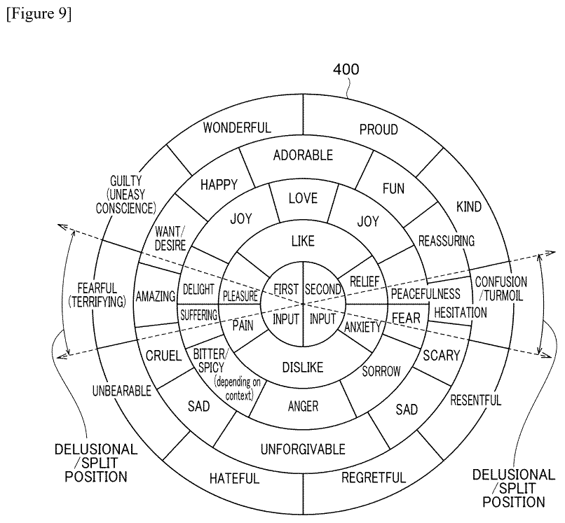

The emotion identification model 59, functioning as an emotion engine, may determine the user's emotion according to a specific mapping. Specifically, the emotion identification model 59 may determine the user's emotion according to an emotion map (see FIG. 9), which is a specific mapping. Furthermore, the emotion identification model 59 may similarly determine the robot's emotion, and the specific processing unit 290 may perform specific processing using the robot's emotion.

FIG. 9 is a diagram showing an emotion map 400 where multiple emotions are mapped. In the emotion map 400, emotions are arranged radially in concentric circles from the center. Emotions closer to the center of the concentric circles represent more primitive states. Emotions representing states or behaviors arising from mental states are arranged further outward on the concentric circles. Emotion is a concept encompassing affect and mental states. Generally, emotions generated from reactions occurring within the brain are placed on the left side of the concentric circles. Generally, emotions induced by situational judgment are placed on the right side of the concentric circles. Generally, emotions generated from reactions occurring within the brain and also induced by situational judgment are placed in the upper and lower directions of the concentric circles. Furthermore, the upper part of the concentric circle contains “pleasant” emotions, while the lower part contains “unpleasant” emotions. Thus, the Emotion Map 400 maps multiple emotions based on the structure of their origin, with emotions that tend to occur simultaneously mapped close together.

These emotions are distributed around the 3 o'clock position on Emotion Map 400, typically oscillating between feelings of security and anxiety. In the right half of Emotion Map 400, situational awareness takes precedence over internal sensations, resulting in a calmer impression.

The inner part of the emotion map 400 represents the mind, while the outer part represents behavior. Therefore, the further out on the emotion map 400, the more visible the emotion becomes (manifesting in behavior).

Here, human emotions are based on various balances, such as posture and blood sugar levels. When these balances deviate from the ideal, it indicates a state of discomfort; when they approach the ideal, it indicates a state of comfort. Similarly, for robots, automobiles, motorcycles, etc., emotions can be created based on various balances, such as posture and battery level. When these balances deviate from the ideal, it indicates a state of discomfort; when they approach the ideal, it indicates a state of comfort. The emotion map is, for example, Dr. Mitsuyoshi's Emotion Map (Based on research on speech emotion recognition and neurophysiological signal analysis of emotions, Tokushima University, Doctoral Dissertation: https://ci.nii.ac.jp/naid/500000375379). The left half of the emotion map displays emotions belonging to the “Reaction” domain, where sensory aspects predominate. The right half of the emotion map displays emotions belonging to the “Situation” domain, where situational awareness is dominant.

Two emotions that promote learning are defined in the emotion map. One is the negative emotion around the center of the “repentance” or “reflection” area on the situation side. That is, when the robot experiences negative emotions like “I never want to feel this way again” or “I don't want to be scolded anymore.” The other is the positive emotion around “Desire” on the reaction side. That is, when the robot feels positive emotions like “I want more” or “I want to know more.”

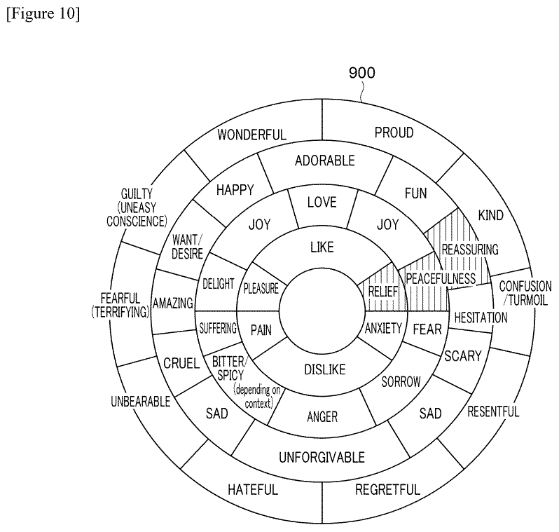

The emotion identification model 59 inputs the user input into a pre-trained neural network, obtains emotion values corresponding to each emotion shown in the emotion map 400, and determines the user's emotion. This neural network is pre-trained based on multiple training data sets, which are combinations of user input and emotion values corresponding to each emotion shown in the emotion map 400. Furthermore, this neural network is trained such that emotions positioned close to each other, as shown in the emotion map 900 in FIG. 10, have similar values. FIG. 10 illustrates an example where multiple emotions, such as “reassurance,” “tranquility,” and “confidence,” have similar emotion values.

The above description primarily explains the system of the present disclosure in terms of the functions of the data processing device 12. However, the system of the present disclosure is not necessarily implemented on a server. The system of the present disclosure may be implemented as a general information processing system. For example, the present disclosure may be implemented as a software program operating on a personal computer or as an application operating on a smartphone, etc. The method of the present disclosure may be provided to users in a SaaS (Software as a Service) format.

The above embodiment illustrated an example configuration where specific processing is performed by a single computer 22. However, the technology of this disclosure is not limited thereto. Distributed processing may be performed by multiple computers, including computer 22, for specific processing. For example, data generation model 58 may be provided in an external device of data processing device 12, and data generation corresponding to input data may be performed in said external device. For example, the data generation model 58 may be provided in an external device of the data processing device 12, and data generation corresponding to input data may be performed in said external device.

The above embodiment described a configuration where a specific processing program 56 is stored in storage 32, but the technology disclosed herein is not limited to this. For example, the specific processing program 56 may be stored on a portable, computer-readable non-volatile storage medium such as a USB (Universal Serial Bus) memory. The specific processing program 56 stored on the non-volatile storage medium is installed on the computer 22 of the data processing device 12. The processor 28 executes specific processing according to the specific processing program 56.

Alternatively, the specific processing program 56 may be stored on a storage device, such as a server, connected to the data processing device 12 via the network 54. Upon request from the data processing device 12, the specific processing program 56 is downloaded and installed on the computer 22.

It should be noted that it is not necessary to store the entire specific processing program 56 on a storage device such as a server connected to the data processing device 12 via the network 54, or to store the entire specific processing program 56 in the storage 32. It is also possible to store only a portion of the specific processing program 56.

Various types of processors can be used as hardware resources to execute the specific processing. Examples of processors include a CPU, which is a general-purpose processor that functions as a hardware resource for executing specific processing by executing software, i.e., a program. Additionally, processors may include dedicated electronic circuits, such as FPGAs (Field-Programmable Gate Array), PLDs (Programmable Logic Device), or ASICs (Application Specific Integrated Circuit), which are processors with circuit configurations specifically designed to execute particular processing tasks. Each processor incorporates or connects to memory and executes specific processing by utilizing this memory.

The hardware resources for executing specific processing may be comprised of one of these various processors, or may be comprised of a combination of two or more processors of the same or different types (e.g., a combination of multiple FPGAs, or a combination of a CPU and an FPGA). Furthermore, the hardware resources for executing specific processing may be a single processor.

Examples of configurations using a single processor include: First, a configuration where one processor is formed by combining one or more CPUs with software, with this processor functioning as the hardware resource executing specific processing. Second, there is a form using a processor that implements the entire system's functionality, including multiple hardware resources executing specific processing, on a single IC chip, as exemplified by a System-on-a-chip (SoC). Thus, specific processing is implemented as a hardware resource using one or more of the various processors described above.

Furthermore, regarding the hardware structure of these various processors, more specifically, electrical circuits combining circuit elements such as semiconductor devices can be used. Also, the specific processing described above is merely one example. Therefore, it goes without saying that within the scope not deviating from the main purpose, unnecessary steps may be omitted, new steps may be added, or the processing order may be changed.

The above description and illustrations provide a detailed explanation of the aspects pertaining to the technology of this disclosure and represent merely one example of the technology disclosed herein. For example, the above descriptions of the configuration, functions, actions, and effects are merely examples of the configuration, functions, actions, and effects of the part pertaining to the technology of the present disclosure. Therefore, it goes without saying that within the scope not deviating from the main purpose of the technology of the present disclosure, unnecessary parts may be omitted, new elements may be added, or replacements may be made to the above-described content and illustrated content. Furthermore, to avoid complexity and facilitate understanding of the technical aspects of the present disclosure, descriptions of common technical knowledge and the like that are not particularly necessary for enabling the present disclosure have been omitted from the above descriptions and illustrations.

All references, patent applications, and technical specifications cited herein are incorporated by reference to the same extent as if each reference, patent application, and technical specification were specifically and individually cited herein.

The following further details are disclosed regarding the above embodiments.

### Supplementary Note 1

A system comprising an analysis unit, a proposal unit, a selection unit, and a payment unit. The analysis unit receives information about the user's mood or health status entered via a terminal, analyzes it using natural language processing technology, and extracts keywords related to emotions or health. The proposal unit searches a database for relevant meals based on the extracted keywords and generates a list to propose to the user. The selection unit allows the user to choose one meal from the proposed list and specify the delivery time and location. The payment unit functions to process payment for the selected meal by linking with a secure payment platform.

A system according to Supplementary Note 1, further comprising a function that selects the optimal store from partner restaurants or delivery services based on the user's location information and confirms the order. The selection unit has the function of coordinating schedules with the delivery service to ensure the order is reliably delivered according to the user's specified delivery time. The proposal unit has the function of proposing meals optimal for the user's health condition based on nutritional value and calorie information stored in the database.

The system described in Supplementary Note 1, further comprising a function that provides options when the user inputs their mood or health status via the user interface. The analysis unit analyzes the input information in real time and provides rapid feedback to the proposal unit. The payment unit supports multiple payment methods and seamlessly completes payment according to the user's selected method. It also sends order confirmation notifications to the user and displays order details.

### EXPLANATION OF SYMBOLS

10, 210, 310, 410 Data Processing System
12 Data Processing Device
14 Smart Device
214 Smart Glasses
314 Headset-type devices
414 Robot

What is claimed is:

1. A data processing system, comprising:
a terminal including a processor, a user interface, and a communication interface;
a server connected to the terminal via a network, the server including:
a processor,
a database storing meal information including dish names, images, nutritional values, calorie information, and restaurant information,
a storage storing a data generation model and an emotion identification model;
wherein the server processor is configured to:
receive, from the terminal, input information representing a user's mood or health status;
analyze the input information using natural language processing to extract keywords and estimate an emotion value using the emotion identification model;
search the database for meals corresponding to the extracted keywords and generate a list of proposed meals including at least dish name and nutritional information;
transmit the list of proposed meals to the terminal for presentation via the user interface;
receive selection information including selection of one meal and specification of at least one of a delivery time or delivery location;
obtain, based on the delivery location, information regarding available stores or restaurants and available delivery times; and
process payment for the selected meal by interfacing with a secure external payment platform.

2. The system of claim 1, wherein the user interface supports text input and voice input.

3. The system of claim 1, wherein the proposal unit personalizes the proposed meals based on past user selection history stored in the database.

4. The system of claim 1, wherein the serving method includes at least one of Cook at Home, Delivery, or Restaurant.

5. The system of claim 1, wherein, when Cook at Home is selected, the server generates a recipe and a list of required ingredients and provides links to nearby supermarkets or online stores.

6. The system of claim 1, wherein the payment processing includes transmitting order confirmation information to the terminal after completion of payment.

7. A computer-implemented method executed by at least one processor of a server connected to a terminal, comprising:
receiving input information regarding a user's mood or health status from the terminal;
analyzing the input information using natural language processing and an emotion identification model to extract keywords and determine an emotion;
searching a database storing meal information including nutritional values and restaurant information to identify meals corresponding to the extracted keywords;
generating a list of proposed meals including dish names and nutritional information;
transmitting the list to the terminal;
receiving selection information including selection of one meal and specification of delivery time or delivery location;
retrieving, based on the delivery location, real-time inventory status or delivery availability information; and
processing payment for the selected meal by linking to a secure payment platform.

8. The method of claim 7, wherein the analyzing includes inputting a prompt to a generative AI model configured to perform inference including analysis, classification, prediction, or summarization.

9. The method of claim 7, wherein the database further stores calorie information and cooking method information for each meal.

10. The method of claim 7, wherein retrieving real-time inventory status includes obtaining price information from nearby stores.

11. The method of claim 7, further comprising transmitting confirmation information to the terminal after payment is completed.

12. The method of claim 7, wherein the emotion identification model determines emotion values corresponding to multiple mapped emotions arranged on an emotion map.

13. A non-transitory computer-readable storage medium storing instructions that, when executed by at least one processor of a server, cause the processor to:
receive mood or health information from a terminal via a network;
analyze the information using natural language processing and an emotion identification model to extract keywords and estimate an emotion;
search a database storing dish names, images, nutritional values, calorie information, and restaurant data to identify meals corresponding to the extracted keywords;
generate and transmit a list of proposed meals to the terminal;
receive a selection of one meal and serving information including delivery time or location;
retrieve location-based store availability information; and
process payment for the selected meal by interfacing with a secure payment platform.

14. The storage medium of claim 13, wherein the analyzing further includes using a data generation model configured to receive a prompt and output inference results.

15. The storage medium of claim 13, wherein the instructions further cause generation of a recipe and ingredient list when Cook at Home is selected.

16. The storage medium of claim 13, wherein the instructions further cause retrieval of available delivery times from partner restaurants.

17. The storage medium of claim 13, wherein the instructions further cause transmission of order confirmation information to the terminal.

18. The storage medium of claim 13, wherein the database is updated to include seasonal menus and newly added dishes.
